(19) United States
(12) Patent Application Publication
(10) Pub. No.: US 2026/0219060 A1
(43) Pub. Date: Jul. 30, 2026

(54) Method and Apparatus for Transferring Positions Between Different Map Data

(71) Applicant: Bayerische Motoren Werke Aktiengesellschaft, Muenchen (DE)

(72) Inventor: Andreas Kopp, Hoehenkirchen-Siegertsbrunn (DE)

(21) Appl. No.: 19/145,823

(22) PCT Filed: Sep. 27, 2023
(86) PCT No.: PCT/EP2023/076656

§ 371 Date: Jul. 3, 2025

(30) Foreign Application Priority Data
Jan. 13, 2023 (DE) 10 2023 100 699.1

(51) Int. Cl. G01C 21/36; G01C 21/00; G01C 21/32

(52) U.S. Cl. CPC G01C 21/3658; G01C 21/32; G01C 21/387

(57) ABSTRACT

A method for referencing a route, based on first map data, of a vehicle to second map data, includes a step of determining first positions on the route with respect to the first map data. The method also includes allocating a lane on which the vehicle is driving at each of the first positions. The first positions are provided with the corresponding allocated lanes. The method further includes determining second positions with respect to the first positions and the corresponding allocated lanes.

The present application is the U.S. national phase of PCT Application PCT/EP2023/076656 filed on Sep. 27, 2023, which claims priority of German patent application No. 10 2023 100 699.1 filed on Jan. 13, 2023, the entire contents of which are incorporated herein by reference.

### TECHNICAL FIELD

The present disclosure relates generally to the field of vehicles, and more particularly systems on board a motor vehicle which use different map data.

### BACKGROUND

A motor vehicle comprises a first and a second system which each process location-related information. For example, the first system can comprise a driver assistance system that can support or control a driving function of the motor vehicle, and the second system can comprise a navigation system that is designed for route planning between a current position and a predetermined target position. The first system is based on first map data and the second is based on second map data.

The first system can determine and provide a planned position of the motor vehicle with respect to the first map data. The first and second map data may differ significantly from each other and/or from reality. The first position, which is incorporated unchanged, may therefore be located outside a road or even on another road when referenced to the second map data.

To transfer a position between first and second map data, it has been proposed to reference the object in a map-agnostic format that does not presuppose map data. However, such an approach is very processing-intensive and is not suitable for processing large numbers of positions, in particular in real time. Another proposal relates to a centrally maintained reference format such as TMC (Traffic Message Channel). However, such formats use relatively coarse grids and are only available on major roads or at major transport hubs.

A position can also be related to absolute geographic coordinates. However, available map data that also use absolute geographic coordinates are usually subject to an error in the range of up to approximately 20 m in the indicated positions. The position of the object can also only be determined from the vehicle with limited accuracy.

There is a need for an improved technique for referencing a position, based on first map data, to second map data.

### SUMMARY

The above-described needs, as well as others, are addressed by one or more embodiment disclosed herein.

A method for referencing a route, based on first map data, of a vehicle to second map data comprises steps of determining first positions on the route with respect to the first map data; allocating a lane on which the vehicle is driving at each of the first positions; providing the first positions with the respectively allocated lanes; determining second positions with respect to the first positions and the respectively allocated lanes.

By transferring a combination of positions and lanes which are respectively allocated to the positions and on which the vehicle is located at each respective position, the positions along the route can easily be related or referenced to the second map data. The method can be executed with any first and second map data.

For example, the map data can use different map systems, different geoids, or different measurement systems. Thus, a lane-accurate transfer of the positions from the first to the second map data can be realized. In particular, the relative indication of a lateral position may result in the transfer of the first position to the second position in such a way that the lane on which the vehicle is currently driven is correctly reproduced. Such a transfer is herein also referred to as lane-accurate.

It is preferable that each lane is related to a road that contains the lane. It can usually be assumed that the vehicle will always be located on a road. The lane can be displayed in relation to the road, for example by counting the lanes of the road from right to left or from left to right. Thus, a lane that is related to a road according to the first map data can easily be converted into a lane that is related to a road according to the second map data.

It is also preferred that the route comprises a reference position at which a first position is known with respect to the first map data and a second position is known with respect to the second map data.

Thus, an absolute deviation of the reference position according to the first map data from the reference position according to the second map data can be determined. This deviation can be applied to positions within a predetermined region around the reference position. This makes it simple and quick to transfer the planned route of the vehicle from the first map data to the second map data.

In particular, the reference position can comprise a current position of the vehicle. The position can be determined by means of one or more positioning systems on board the vehicle. Measurements of the positioning systems can form a basis for determining the current position of the vehicle with reference to the different map data. The route is preferably a planned route that extends forwards from the current position of the vehicle in the direction of travel.

In one embodiment, the first positions are included in a polyline. The polyline can represent a sequence of positions that are chained together. This allows a position to be specified in a relative manner with respect to a previous or subsequent position. Data to be transferred can be reduced and processing of the positions can be simplified.

It is also preferred that a sequence of predetermined first positions comprises a change in the lane on which the vehicle is driven. Using the method presented here, such a driving maneuver can easily be transferred from the first to the second map data.

It is possible to express a position in terms of its distance from the reference position along the road as well as by an indication of the lane being used. For example, a change lane maneuver may comprise an indication that, starting from a current position of the vehicle as a reference position, a change from the second lane to the third lane of the road being driven on should take place from the right at approximately 50 meters along the road being driven on.

If, according to the f data, lanes are not defined in the region of a first position, the first position can be assigned an indication of an undefined lane. For example, an undefined lane can apply in the region of an intersection or during a turn maneuver. The shape of a bend, which is described by first positions in this region, can be fitted in accordingly between second positions before and after the region. This allows the route to display a realistic course with respect to the second map data.

If the second map data do not include lane information in the region of the second position, a lateral position of the second position with regard to a boundary of the road being driven on can be determined. For example, if the vehicle is to drive on the second lane from the right with respect to the first map data and the road has four lanes according to the first map data, the lateral position of the vehicle can be determined with respect to the second map data by dividing the road according to the second map data into four sections of equal width, which can be treated as lanes.

The lane currently being driven on can be determined as a region, the lateral distance thereof to the right edge of the road according to the second map data is between one and two widths. This allows the vehicle to be positioned on different “virtual” lanes with respect to the second map data. It is irrelevant whether lanes are drawn on the road or not.

In general, it is preferred that the first map data have a higher level of detail and/or higher accuracy than the second map data. For example, the first map data may be included in a driver assistance system and/or the second map data may be included in a navigation system. The driver assistance system can determine with high reliability a lane being driven on by the vehicle. The described method facilitates the use of this reliability or accuracy as the basis of an indication with respect to the second map data.

An apparatus for referencing a first route, based on first map data, of a vehicle to second map data includes a first map store for the first map data; a second map store for the second map data; and a processing device. The processing device is configured to determine first positions on the route with respect to the first map data; allocate a lane on which the vehicle is driving at each of the first positions; provide the first positions with the respectively allocated lanes; and determine second positions with respect to the first positions and the respectively allocated lanes.

The processing device may be designed to perform a method described herein in part or in full. For this purpose, the processing device may be implemented electronically and comprise, for example, a programmable microcomputer or microcontroller. The method can be provided in the form of a computer program product with program code means. The computer program product can also be stored on a computer-readable data carrier. Features or advantages of the method can be transferred to the apparatus or vice versa.

A vehicle comprises an apparatus described herein. The vehicle preferably consists of a motor vehicle, in particular a motorcycle, a passenger car, a heavy goods vehicle or a bus.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 shows an exemplary embodiment of apparatus on board a vehicle according to the disclosure;

FIG. 2 shows a flow chart of an exemplary method according to the disclosure; and

FIG. 3 shows an example route of a vehicle.

### DETAILED DESCRIPTION

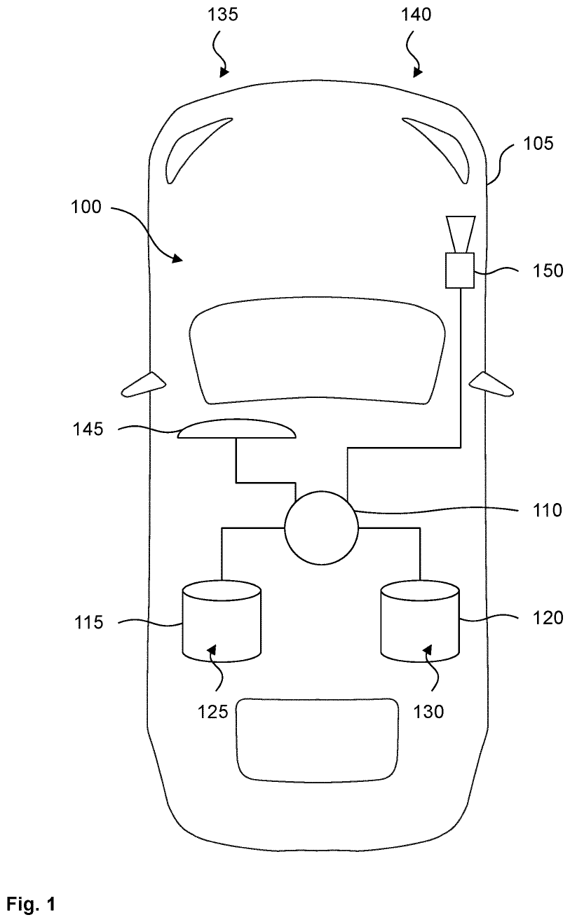

FIG. 1 shows an apparatus 100 on board a vehicle 105. The vehicle 105 is shown as a passenger car as an example; in other embodiments, another type of vehicle may also be included. The apparatus 100 comprises a processing device 110, a first map store 115 and a second map store 120. The map stores 115, 120 are each designed for storing map data. The first map data 125 are stored in the first map store 115 and second map data 130 in the second map store 120.

Purely as an example, the first map data 125 are highly accurate (HD: High Definition) and can be used by a first system 135, which may comprise, for example, a driver assistance feature, automatic or autonomous control of the vehicle 105. The second map data 130 are, for example, of single accuracy (SD: Single Definition) and can be used by a second system 140 which comprises a navigation system as an example.

The map data 125 and 130 are used for different purposes and can be optimized accordingly to satisfy different criteria. For example, the first map data 125 may be optimized mainly with respect to lanes forming part of a navigable road or to a classification of roads, for example into minor roads, highways and motorways. The second map data 130 can be optimized with respect to actuality, traffic rules or traffic flow information. This allows a driving maneuver by the vehicle 105 to be displayed in an improved way with respect to the first map data 125, while it may be easier to determine a favorable route with respect to the second map data 130.

A positioning device 145 may be provided for determining the geographical position of the vehicle 105. The positioning device 145 illustrated is designed as a receiver of a satellite-based global navigation system (GNSS) such as GPS, Glonass or Galileo. An exemplary further possible means of determining the position of the vehicle 105 is provided in the illustration of FIG. 1 by a camera 150, which is designed to scan a landmark in an environment of the vehicle 105. A geographical position of the landmark can be determined on the basis of first or second map data 125, 130. With respect to multiple landmarks, the position of the vehicle 105 can be determined.

To transfer a route between the first and second systems 135, 140, it is proposed to convert the route into a sequence of positions that are related to the first map data 125. The positions can then be augmented with information that determines a lateral and/or longitudinal position with respect to the first map data 125 more precisely and which can be transferred to the second map data 130.

A longitudinal position specification can include a distance from a predetermined position along a road being driven on. A transversal position can relate to a numerically specified lane of the road. The additional information can then be analyzed with respect to the second map data 130 on the basis of the transferred positions.

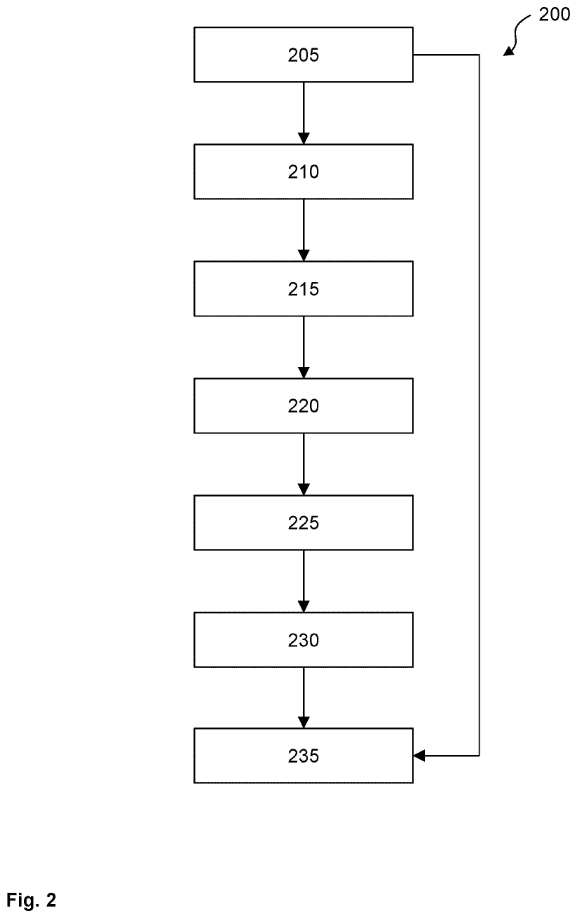

FIG. 2 shows a flow chart of a method 200 for referencing a route, based on first map data 125, to second map data 130. The method 200 may be executed in particular by means of the device 100 on board the vehicle 105.

In a step 205, a geographical position of the vehicle 105 can be determined. This position is also called the ego position and is related to a predetermined point in time.

In a step 210, a planned route of the vehicle 105 can be determined. For example, the route can be defined by the first system 135 and implement a predetermined driving maneuver of the vehicle 105 in detail, such as a turning maneuver. The route usually extends on a predetermined road section, which may be limited in length, for example to approximately 1 km, approximately 500 m, approximately 200 m or approximately 100 m.

In a step 215, first positions can be specified that are based on the first map data 125 and represent the route. A number of first positions is not limited; however, at least enough should be determined such that a maneuver implemented by the route can be uniquely and completely represented.

In a step 220, a polyline can be formed that connects the first positions together in their sequence on the route.

In other words: the polyline can consist of a sequence of first positions.

In a step 225, a lane driven on or to be driven on by the vehicle 105 can be determined for each first position on the polyline. Information about lanes included in a road being driven on can be determined from the first map data 125. The lateral position of the vehicle 105 on the road can be expressed as an integer representing the lane currently being driven on.

In addition, the first positions can be augmented with distances from other first positions. In a particularly preferred embodiment, a reference position is determined to which the positions of the route relate in the longitudinal direction of the road.

The first positions, which are each augmented with additional information, can be provided to the second system 140 in absolute terms or in the form of a sequence, for example as a polyline, in a step 225.

In a step 235, the first positions of the route can be related to the second map data 130. For this purpose, the information by which the first positions were augmented can be analyzed and related to the second map data 130. For example, a lateral position of the vehicle 105 can also be determined here with respect to a number of known lanes of a road being driven on. A longitudinal position along the road can be determined with respect to a predetermined reference position. In particular, the ego position recorded in step 205 can be used as a reference position with respect to the second map data 130.

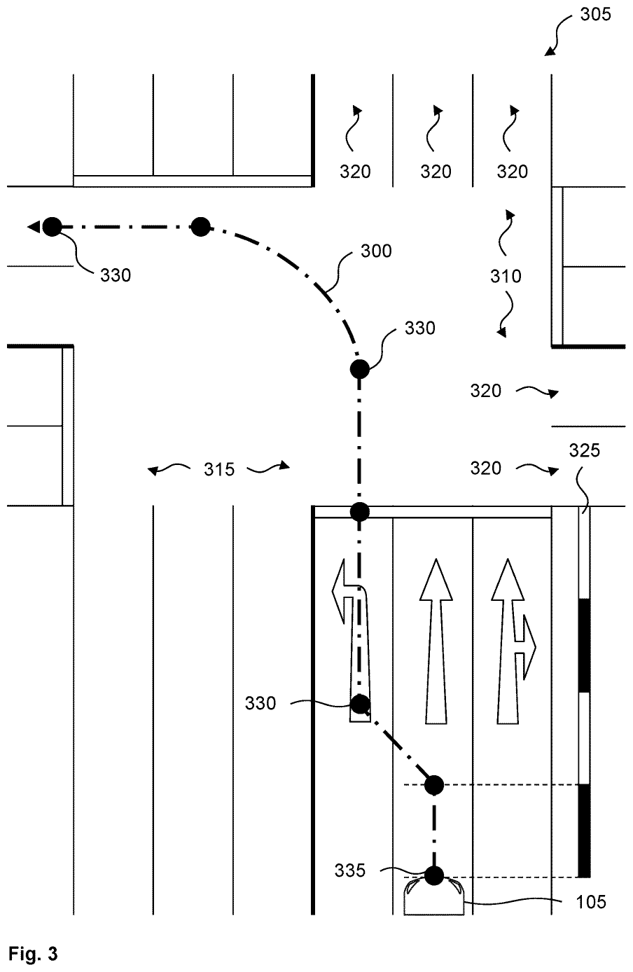

FIG. 3 shows an example route 300 which the vehicle 105 intends to drive. The route 300 describes a turn maneuver at an intersection 305. In FIG. 3, a first road 310 extends vertically and a second road 315 extends in a horizontal direction. The first road 310 has three lanes 320 per direction of travel, while the second road 315, for example, comprises only two lanes 320 per direction of travel.

The vehicle 105 is located at the lower edge of FIG. 3 with the direction of travel upwards on a middle lane 320 of the first road 310. For easier reference, an example scale 325 is shown to the right of the first road 310, indicating units of 50 m along the first road 310. The route 300 comprises a number of first positions 330, illustrated by way of example by circles in FIG. 3. A current position of the vehicle 105 as shown in FIG. 3 may be defined as a reference position 335. The reference position 335 can be defined with respect to both the first map data 125 and the second map data 130.

The route 300 specifies that the vehicle 105, after driving approximately 50 m on the middle lane 320 of the first road 310, changes to the lane to the left and continues straight on to the stop line. When traffic permits, the vehicle 105 should then turn left in an arc and continue driving in the right lane of the second road 315.

The first positions 330 can each be augmented by longitudinal and/or transversal information. In the intersection region where the roads 310, 315 cross, no lanes 320 are defined. Here, the first positions 330 can be augmented by the information that a definition of lanes 320 is not possible or is not provided in the first map data 125.

The augmented first positions 330 of the route 300 can be transferred to the second system 140 and then be dereferenced there with respect to the second map data 130. Starting from the reference position 335, both longitudinal and transversal additional information can be analyzed. This allows the route 300 to also be expressed with respect to the second map data 130. For example, the defined route 300 can then be output on a map display on board the vehicle 105.

### REFERENCE SIGNS

100 apparatus
105 vehicle
110 processing device
115 first map store
120 second map store
125 first map data
130 second map data
135 first system
140 second system
145 positioning device
150 camera
200 method
205 capturing ego position
210 determining planned route
215 defining first positions
220 forming polyline
225 determining lanes used in each case
230 providing positions with allocated lanes
235 determining second positions
300 route
305 intersection
310 first road
315 second road
320 lane
325 scale
330 first position
335 reference position

1.-12. (canceled)

13. A method for referencing a route, based on first map data, of a vehicle to second map data, the method comprising:
determining first positions on the route with respect to the first map data;
allocating a lane on which the vehicle is driving at each of the first positions;
providing the first positions with corresponding allocated lanes; and
determining second positions with respect to the first positions and the corresponding allocated lanes.

14. The method as claimed in claim 13, wherein each lane is related to a road comprising the lane.

15. The method as claimed in claim 13, wherein the route comprises a reference position at which a corresponding first position is known with respect to the first map data and a corresponding second position is known with respect to the second map data.

16. The method as claimed in claim 15, wherein the reference position comprises a current position of the vehicle.

17. The method as claimed in claim 16, wherein the first positions are included in a polyline generated by a processing circuit of the vehicle.

18. The method as claimed in claim 13, wherein the first positions are included in a polyline generated by a processing circuit of the vehicle.

19. The method as claimed in claim 18, further comprising allocating an indication of an undefined lane for a selected first position) if, according to the first map data, lanes are not defined in a region of the selected first position.

20. The method as claimed in claim 13, wherein a sequence of predetermined first positions comprises a change of the lane on which the vehicle is driving.

21. The method as claimed in claim 13, further comprising allocating an indication of an undefined lane for a selected first position) if, according to the first map data, lanes are not defined in a region of the selected first position.

22. The method as claimed in claim 21, further comprising determining a lateral location of at least one of the second positions with respect to a boundary of a road currently being driven on, if the second map data in the region of the at least one of the second position does not include lane information.

23. The method as claimed in claim 13, further comprising determining a lateral location of at least one of the second positions with respect to a boundary of a road currently being driven on, if the second map data in a region of the second position does not include lane information.

24. The method as claimed in claim 13, wherein the first map data has a higher degree of detail than the second map data.

25. The method as claimed in claim 13, wherein the first map data has a higher accuracy than the second map data.

26. The method as claimed in claim 13, wherein the first map data is included in a driver assistance system and the second map data is included in a navigation system.

27. The method as claimed in claim 13, wherein the first map data is included in a driver assistance system or the second map data is included in a navigation system.

28. An apparatus for referencing a route, based on first map data, of a vehicle to second map data, the apparatus comprising:
a first map store for the first map data;
a second map store for the second map data; and
a processing device, which is configured to:
determine first positions on the route with respect to the first map data;
allocate a lane on which the vehicle is driving at each of the first positions;
provide the first positions with corresponding allocated lanes; and
determine second positions with respect to the first positions and the corresponding allocated lanes.

29. A vehicle, comprising an apparatus as claimed in claim 28.

30. A method comprising:
providing first map data used by a first vehicle system relating to a route of the vehicle;
determining first positions on the route with respect to the first map data;
allocating a lane on which the vehicle is driving at each of the first positions;
providing the first positions with corresponding allocated lanes;
determining second positions in the second map data with respect to the first positions and the corresponding allocated lanes; and
using the second map data in a second vehicle system.

31. The method as claimed in claim 30, wherein the first vehicle system is a driver assistance system and the second vehicle system is a navigation system.

32. The method as claimed in claim 30, wherein the first vehicle system is a driver assistance system or the second vehicle system is a navigation system.
